(19) United States
(12) Patent Application Publication
(10) Pub. No.: US 2012/0105447 A1
(43) Pub. Date: May 3, 2012

(54) AUGMENTED REALITY-BASED DEVICE CONTROL APPARATUS AND METHOD USING LOCAL WIRELESS COMMUNICATION

(75) Inventor: Hae-Yong KIM, Daejeon (KR)

(73) Assignee: ELECTRONICS AND TELECOMMUNICATIONS RESEARCH INSTITUTE, Daejeon (KR)

(21) Appl. No.: 13/286,671

(22) Filed: Nov. 1, 2011

(30) Foreign Application Priority Data
Nov. 2, 2010 (KR) 10-2010-0108346

(51) Int. Cl. G09G 5/00; G06T 15/00

(52) U.S. Cl. 345/419; 345/633

(57) ABSTRACT

The present invention relates to an augmented reality-based device control apparatus and method using local wireless communication. The device control apparatus includes an ID registration unit for registering ID information about a control target device located near the device control apparatus, and requesting and registering detailed information about an image and function of the control target device. An image analysis unit analyzes an image of the control target device captured by a camera. A device recognition unit compares a result of analysis of the image with the detailed information about the control target device, thus recognizing the to control target device. A control unit requests current state information from the control target device using the ID information about the control target device and displays the current state information and the detailed information about the function of the control target device, together with the image of the control target device.

### CROSS REFERENCE TO RELATED APPLICATION

This application claims the benefit of Korean Patent Application No. 10-2010-0108346, filed on Nov. 2, 2010, which is hereby incorporated by reference in its entirety into this application.

### BACKGROUND OF THE INVENTION

1. Technical Field

The present invention relates generally to an augmented reality-based device control apparatus and method using local wireless communication and, more particularly, to an augmented reality-based device control apparatus and method using local wireless communication, which recognize, by means of augmented reality, control target devices that are located a short distance away and are equipped with a wireless communication function, thus enabling the control target devices to be controlled.

2. Description of the Related Art

Augmented reality is technology that aims to improve users' convenience by combining a virtual image generated by a computer or a user terminal with a realistic image on the basis of information about the realistic image. Such augmented reality technology is based on the recognition of objects appearing in a realistic image.

Methods of recognizing objects are classified into a marker-based method that uses a unique specific marker and a marker-less method that identifies an object by recognizing an object image itself.

The marker-based method is implemented in such a way that an application program capable of decrypting a relevant marker and showing specific information is operated in conjunction with a user terminal, or in such a way that that relevant marker image information is transmitted to a server located a long distance away and information associated with the relevant marker is received from the server.

The marker-less method adopts a scheme in which most terminals, held by users and configured to provide augmented reality technology, transmit realistic images to a server located a long distance away and the server processes the images to identify relevant objects and retransmits possible information, which can be provided from the processed images, to the terminals of the users, due to performance limitations. Such a marker-less method may additionally utilize Global Positioning System (GPS) information and gyro sensor information to obtain location information about users so that objects can be more precisely recognized.

In this way, the conventional augmented reality technology merely provides additional information which may be usable for a user from realistic images, or only enables a specific application to be executed on a user terminal, and does not provide functions such as the control of devices via interacting with the devices.

### SUMMARY OF THE INVENTION

Accordingly, the present invention has been made keeping in mind the above problems occurring in the prior art, and an object of the present invention is to provide an augmented reality-based device control apparatus and method using local wireless communication, which not only can obtain information using bidirectional communication with objects in the real world, but also can control those objects, unlike the conventional augmented reality technology which was just at the level of recognizing actual objects and only providing additional information to a user.

Another object of the present invention is to provide an augmented reality-based device control apparatus and method using local wireless communication, which utilize local wireless communication, thus enabling devices to be controlled without the help of a server located a long distance away.

In accordance with an aspect of the present invention to accomplish the above objects, to there is provided an augmented reality-based device control apparatus using local wireless communication, including an identification (ID) registration unit for registering ID information about a control target device located near the device control apparatus, and requesting and registering detailed information about an image and a function of the control target device, an image analysis unit for analyzing an image of the control target device captured by a camera, a device recognition unit for comparing a result of analysis of the image by the image analysis unit with the detailed information about the control target device registered by the ID registration unit, thus recognizing the control target device, and a control unit for requesting current state information from the control target device using the ID information about the control target device recognized by the device recognition unit and displaying the current state information received from the control target device and the detailed information about the function of the control target device, together with the image of the control target device.

Preferably, the detailed information about the control target device may include at least one of a device name of the control target device, three-dimensional (3D) image information including size and color information of the control target device, control information about the function of the control target device, location information about the control target device, and information about surroundings of the control target device.

Preferably, the control unit may display an augmented reality screen required to control the control target device, based on the current state information of the control target device and the control information of the control target device.

Preferably, the ID registration unit may be configured to recognize and register an ID of the control target device by means of at least one marker attached to the control target device if the marker is attached to the control target device.

Preferably, the ID registration unit may be configured to receive an ID of the control target device from a user and register the ID if at least one marker is not attached to the control target device.

Preferably, the ID registration unit may request the detailed information about the control target device from the control target device, based on the ID information about the control target device, and store the detailed information about the control target device to correspond to the ID information.

Preferably, the augmented reality-based device control apparatus may further include a communication module wirelessly connected to the control target device located near the device control apparatus and configured to transmit or receive signals to or from the control target device, wherein the communication module communicates with the control target device using at least one of Zigbee, IPv6 over Low power Wireless Personal Area Network (6LoWPAN), Bluetooth, Wireless Fidelity (WIFI), and infrared communication.

In accordance with another aspect of the present invention to accomplish the above objects, there is provided an augmented reality-based device control method using local wireless communication, including registering identification (ID) information about a control target device located at a nearby location, and requesting and registering detailed information about an image and a function of the control target device, analyzing an image of the control target device captured by a camera, comparing a result of analysis of the image with the registered detailed information about the control target device, thus recognizing the control target device, requesting current state information from the control target device using the registered ID information about the control target device, and displaying the current state information received from the control target device and the detailed information about the function of the control target device, together with the image of the control target device.

Preferably, the detailed information about the control target device may include at least one of a device name of the control target device, three-dimensional (3D) image information including size and color information of the control target device, control information about the function of the control target device, location information about the control target device, and information about surroundings of the control target device.

Preferably, the displaying may include displaying an augmented reality screen required to control the control target device, based on the current state information of the control target device and the control information of the control target device.

Preferably, the registering may include, if at least one marker is attached to the control target device, capturing the marker, and recognizing and registering an ID of the control target device by means of the marker.

Preferably, the registering may include, if at least one marker is not attached to the control target device, receiving an ID of the control target device from a user and registering the ID.

Preferably, the registering may further include requesting the detailed information about the control target device from the control target device, based on the ID information about the control target device, wherein the detailed information about the control target device is stored to correspond to the ID information.

Preferably, the registering may be initially performed only once for an identical control target device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a system to which an augmented reality-based device control apparatus using local wireless communication according to the present invention is applied;

FIG. 2 is a block diagram showing the construction of an augmented reality-based device control apparatus using local wireless communication according to the present invention;

FIGS. 3 and 4 are diagrams illustrating an operation of performing communication between the augmented reality-based device control apparatus using local wireless communication according to the present invention and a control target device;

FIGS. 5 and 6 are diagrams showing an operation of controlling a control target device in the augmented reality-based device control apparatus using local wireless communication according to the present invention;

FIG. 7 is a flowchart showing a procedure for registering a control target device in the augmented reality-based device control method using local wireless communication according to the present invention; and

FIG. 8 is a flowchart showing the operating flow of the augmented reality-based device control method using local wireless communication according to the present invention.

### DESCRIPTION OF THE PREFERRED EMBODIMENTS

Hereinafter, embodiments of the present invention will be described in detail with reference to the attached drawings.

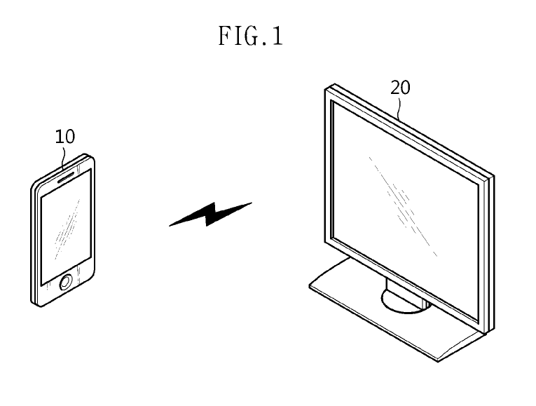

FIG. 1 is a diagram showing the construction of a system to which an augmented reality-based device control apparatus using local wireless communication according to the present invention is applied.

As shown in FIG. 1, the augmented reality-based device control apparatus using local wireless communication according to the present invention is a user terminal 10 which may to correspond to a mobile communication terminal, a computer, or the like. In the following description, the device control apparatus will be described as being the user terminal 10. Of course, it is apparent that the device control apparatus described in the accompanying claims also corresponds to the user terminal 10 in the detailed description of the present specification.

The user terminal 10 acquires information about a control target device 20 located in the real world in augmented reality by using images obtained by capturing the control target device 20 such as a television (TV), a monitor, a Digital Versatile Disc (DVD) player, or a household electric appliance which is located a short distance away, and controls the relevant control target device 20.

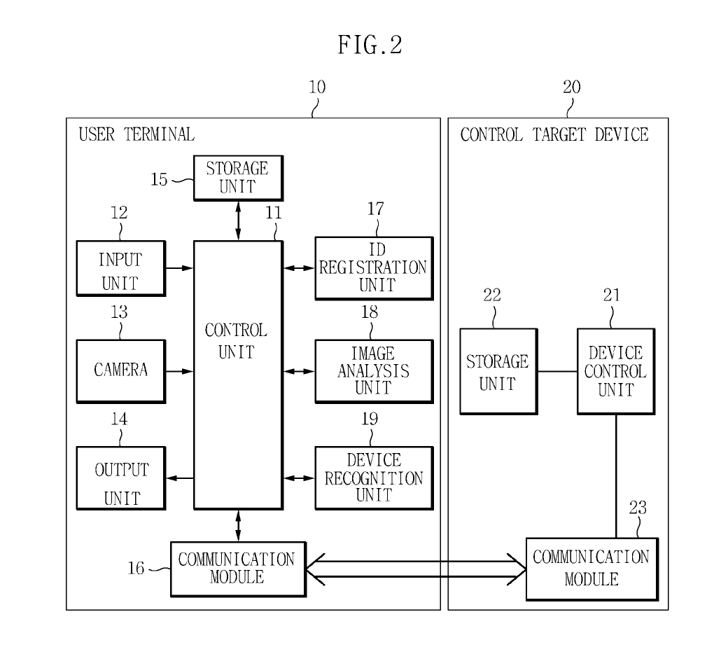

In this case, the user terminal 10 basically includes an image acquisition means for capturing images of the control target device 20, a display means for displaying images, and a wireless communication means for communicating with the control target device 20. Further, the control target device 20 includes a storage means for storing information about the control target device 20 and a wireless communication means for communicating with the user terminal 10. Detailed construction of each of the user terminal 10 and the control target device 20 will be described with reference to an embodiment of FIG. 2.

FIG. 2 is a block diagram showing the construction of the augmented reality-based device control apparatus using local wireless communication according to the present invention.

Referring to FIG. 2, a user terminal 10 includes a control unit 11, an input unit 12, a camera 13, an output unit 14, a storage unit 15, and a communication module 16. Here, the control unit 11 controls the operations of the individual units of the user terminal 10.

The input unit 12 receives control commands from a user. The camera 13 captures an image required to recognize the identification (ID) of a control target device 20 with a marker attached thereto, and also captures an image required to recognize the control target device 20 registered on the user terminal 10. The output unit 14 displays the images captured by the camera 13. Further, the output unit 14 displays the current state information and the control information of a recognized control target device 20, together with captured images if the control target device 20 has been recognized by the control unit 11.

The storage unit 15 stores the images captured by the camera 13. Further, the storage unit 15 stores ID information about the control target device 20 recognized by the control unit 11 and detailed information about the control target device 20 corresponding to the ID information. For example, the storage unit 15 stores the device name of the control target device 20, a three-dimensional (3D) image including the size and color information of the control target device 20, and the functions, control information and location information of the control target device 20, together with the ID information about the control target device 20. Further, the storage unit 15 may also store information about images of surroundings of the control target device 20.

Subsequently, when images of the control target device 20 are captured by the camera 13, the control unit 11 compares the detailed information of the control target device 20 registered in the storage unit 15 with the captured images, and then recognizes the ID of the control target device 20.

The communication module 16 is wirelessly connected to the control target device 20 to transmit or receive signals to or from the control target device 20. Here, the communication module 16 is capable of communicating with the control target device 20 using 802.15.4 standard-based communications such as Zigbee, IPv6 over Low power Wireless Personal Area Network (6LoWPAN), Bluetooth, Wireless Fidelity (WIFI), and infrared communication.

Meanwhile, an ID registration unit 17 registers the ID of the relevant control target device 20 so as to check the information about the control target device 20 located near the user terminal or control the control target device 20. In this case, when the image of the control target device 20 is captured by the camera 13, the ID registration unit 17 recognizes the marker attached to the control target device 20, and then identifies the ID of the control target device 20. The ID registration unit 17 registers the ID of the control target device 20 identified by the marker in the storage unit 15.

Here, the registration of the ID is initially performed only once. Of course, when a marker is not attached to a relevant control target device 20, the ID registration unit 17 may manually receive the ID information about the control target device 20 from the user and register the ID information.

If the ID of the control target device 20 has been registered by the ID registration unit 17, the communication module 16 performs wireless communication with the control target device 20 using the registered ID.

In this case, the ID registration unit 17 collects the device name of the control target device 20, 3D image information including the size and color information of the control target device 20, and control information related to various functions of the control target device 20, by using the registered ID, and stores the collected information in the storage unit 15.

Thereafter, since the user terminal 10 stores therein 3D image information including the size and color information of the control target device 20, the user can analyze image information input via the camera 13 only by capturing the image of the control target device 20 using the camera 13 without performing any separate manipulation, thus automatically analyzing the type of the relevant control target device 20.

In other words, when the image of the control target device 20 is input via the camera 13, an image analysis unit 18 analyzes the input image, and a device recognition unit 19 recognizes the relevant control target device 20 based on the result of the image analysis carried out by the image analysis unit 18. In this case, the device recognition unit 19 compares the 3D image information stored in the storage unit 15 with the input image, and then recognizes the relevant control target device 20.

As another embodiment, when the image of the control target device 20 is input via the camera 13, the device recognition unit 19 can recognize a marker attached to the control target device 20 from the input image and recognize the control target device 20 using the marker.

When the control target device 20 is recognized, the control unit 11 can extract the information about the control target device 20, stored in the storage unit 15, and display the extracted information together with the image of the control target device 20 input via the camera 13. Of course, the control unit 11 may extract the function control information of the control target device 20, and display an augmented reality screen for controlling the control target device 20.

The augmented reality screen related to control can vary according to the control target device 20, and in this case, it is possible not only to simply provide a control function to the user, but also to additionally receive and show the current state information of the control target device 20.

Meanwhile, the control target device 20 according to the present invention includes a device control unit 21, a storage unit 22, and a communication module 23. In this case, the device control unit 21 includes the operations of the individual units of the control target device 20.

The storage unit 22 stores the current state information of the control target device 20, the device name of the control target device 20, a 3D image including the size and color information of the control target device 20, and the functions, control information, and location information of the control target device 20. The communication module 23 is wirelessly connected to the user terminal 10 to transmit or receive signals to or from the user terminal 10. In this case, the communication module 23 is capable of communicating with the user terminal 10 using 802.15.4 standard-based communications such as Zigbee, 6LoWPAN, Bluetooth, WIFI, and infrared communication.

When a request for detailed information about the relevant control target device 20 is received from the user terminal 10 using the ID of the control target device 20, the device control unit 21 may extract detailed information stored in the storage unit 22 from the storage unit 22, and transmit the detailed information to the user terminal 10 via the communication module 23. Further, whenever a request for current state information is received from the user terminal 10, the device control unit 21 extracts the stored current state information and transmits the current state information to the user terminal 10.

Meanwhile, when a predetermined control command is input from the user terminal 10, the device control unit 21 executes the input control command, and transmits a control value related to the result of the execution of the control command to the user terminal 10 via the communication module 23.

Of course, although not shown in FIGS. 1 and 2, a marker required to recognize the ID information about the control target device 20 or to recognize the control target device 20 itself may be attached to the control target device 20.

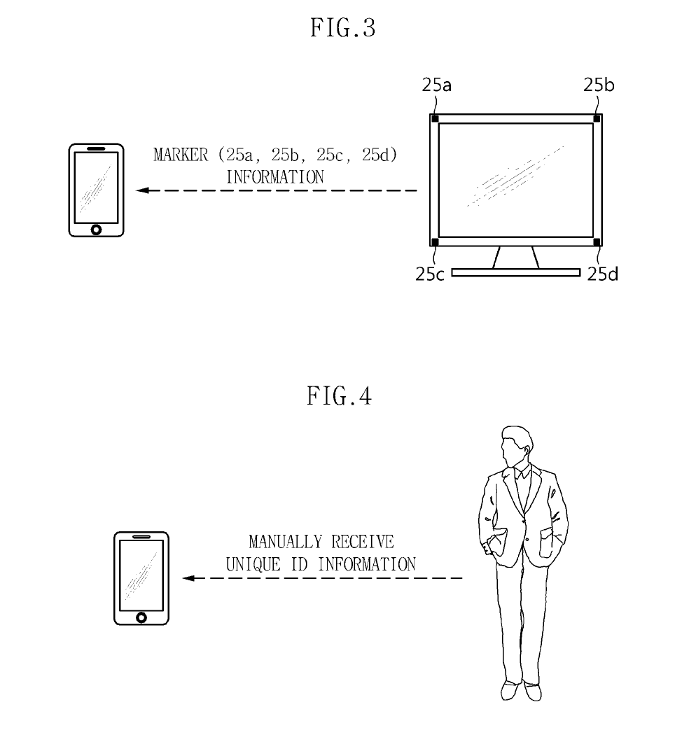

FIGS. 3 and 4 are diagrams showing the operation of performing communication between the augmented reality-based device control apparatus using local wireless communication according to the present invention and the control target device 20.

In particular, FIGS. 3 and 4 illustrate embodiments in which information is input from a relevant control target device 20 so as to initially register the ID of the control target device 20.

First, FIG. 3 illustrates the case where markers are attached to the control target device 20.

As shown in FIG. 3, the user terminal 10 captures images of markers 25a, 25b, 25c, and 25d attached to the control target device 20 using the camera 13 so as to register the ID of the control target device 20 to which the markers 25a, 25b, 25c, and 25d are attached.

In this case, the user terminal 10 can easily acquire the ID information about the control target device 20 from the captured markers 25a, 25b, 25c, and 25d. Therefore, the user terminal 10 registers the ID received from the control target device 20, and is then capable of subsequently communicating with the control target device 20 using the ID.

Meanwhile, FIG. 4 illustrates the case where markers are not attached to the control target device 20.

As shown in FIG. 4, in the case of a control target device 20 which has no markers attached thereto, the user terminal 10 can manually receive the ID of the control target device 20 from a user. Of course, the user can identify the ID information described on the operating manual of the control target device 20 or ID information described on the control target device 20.

In this case, the user terminal 10 registers the ID of the control target device 20 which has been input from the user, and is then capable of subsequently communicating with the control target device 20 using the relevant ID.

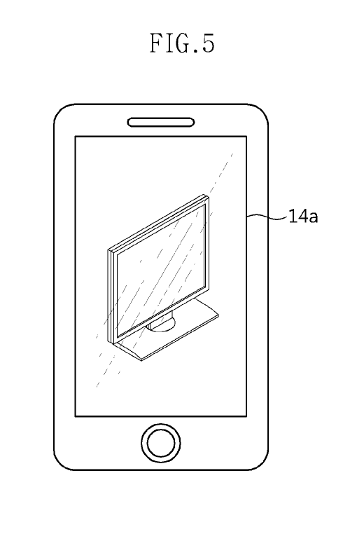

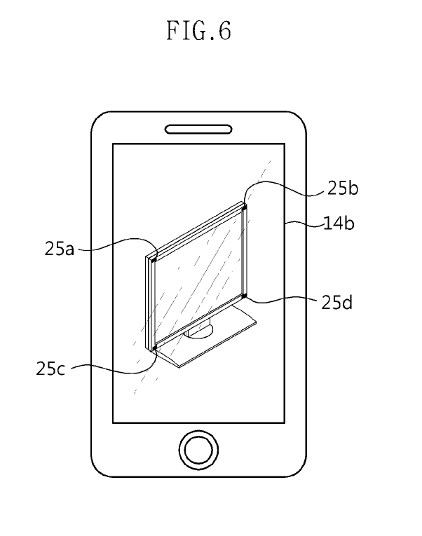

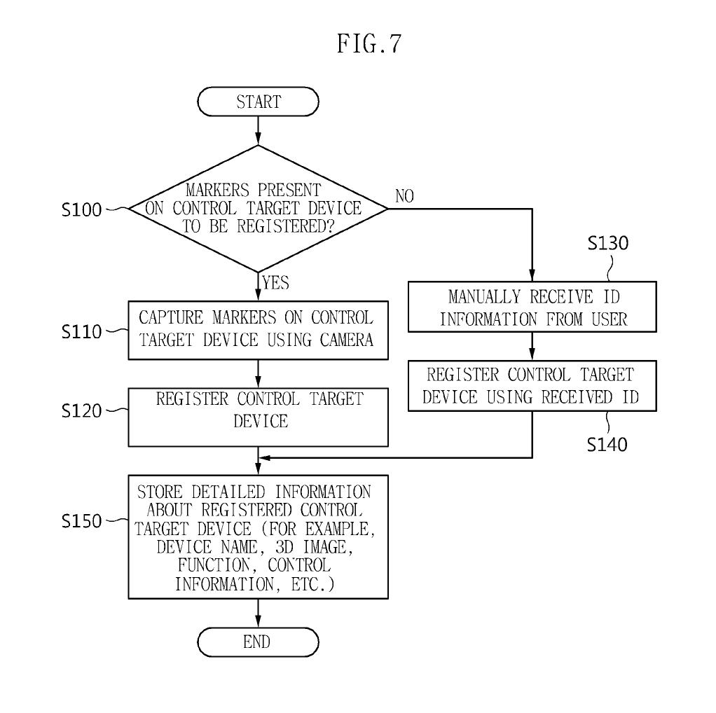

FIGS. 5 and 6 are diagrams illustrating the operation of controlling a control target device in the augmented reality-based device control apparatus using local wireless communication according to the present invention.

As shown in FIG. 5, when an image of a control target device 20, the current state of which is intended to be checked or which is desired to be controlled, is captured using the camera 13, the user terminal 10 of the present invention recognizes the control target device 20, included in the captured image, among previously registered devices by analyzing the image displayed on the screen 14a of the user terminal 10.

If two or more control target devices 20 of the same type are registered, the user terminal 10 can recognize the control target device 20 included in the captured image by comparing at least one of location information about the captured control target device 20, that is, GPS location information or location information obtained using a gyro sensor, and information about the surroundings of the captured control target device 20.

Meanwhile, as shown in FIG. 6, when an image of the control target device 20 is captured using the camera 13 in the state in which the markers 25a, 25b, 25c, and 25d are attached to the control target device 20, the user terminal 10 recognizes the control target device 20 by means of the markers 25a, 25b, 25c, and 25d in the image displayed on the screen 14b of the user terminal 10.

Therefore, the user terminal 10 may receive current state information from the control target device 20 on the basis of the registered information of the recognized control target device 20 and may display the current state information together with the image displayed on the screen 14a or 14b or may display the registered control information or control information that is newly received from the control target device 20 together with the image displayed on the screen 14a or 14b.

Hereinafter, a method of operating the augmented reality-based device control apparatus using local wireless communication having the above construction will be described in greater detail.

FIG. 7 is a flowchart showing a procedure for registering a control target device in an augmented reality-based device control method using local wireless communication according to the present invention.

As shown in FIG. 7, when desiring to register a control target device 20 to be controlled, the user terminal 10 of the present invention determines whether markers are present on the control target device 20 to be registered.

If it is determined that markers are present on the relevant control target device 20 at step S100, the user terminal 10 operates the camera 13 to capture images of the markers on the control target device 20 at step S110, and registers the ID of the control target device 20 using the captured markers at step S120.

In contrast, if it is determined that markers are not present on the control target device 20 at step S100, the user terminal 10 manually receives the ID information about the control target device 20 from the user at step S130, and registers the ID of the control target device 20 at step S140.

Thereafter, the user terminal 10 communicates with the control target device 20 using the registered ID, and stores detailed information to correspond to the ID of the control target device 20 at step S150. In this case, the detailed information about the control target device 20 includes a device name, a 3D image including size and color information, functions, control information, etc.

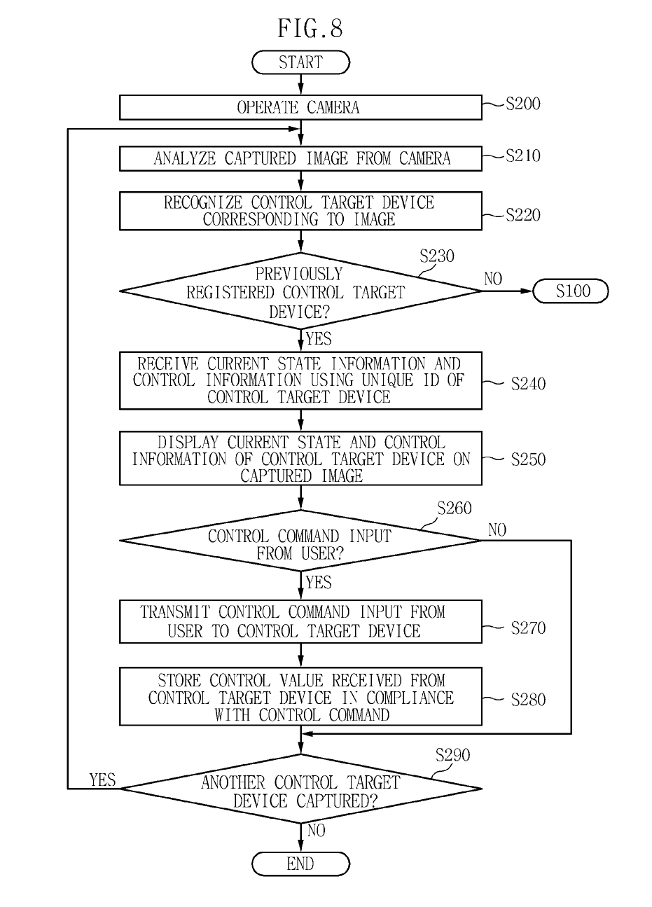

In this way, the procedure for registering the control target device 20 is completed. If the registration of the control target device 20 has been completed, as shown in FIG. 7, the current state of the control target device 20 can be checked or the control target device 20 can be controlled later via the procedure of FIG. 8.

FIG. 8 is a flowchart showing the operating flow of the augmented reality-based device control method using local wireless communication according to the present invention.

As shown in FIG. 8, the user terminal 10 according to the present invention primarily operates the camera 13 to capture an image of a control target device 20 that is to be controlled in order to check the current state of the control target device 20 or to control the control target device 20 at step S200. The user terminal 10 analyzes the image captured by the camera 13 at step S210, and then recognizes the control target device 20 corresponding to the captured image at step S220.

In this case, if the control target device 20 corresponding to the image is not a device registered on the user terminal 10 at step S230, the procedure starting from step S100 of FIG. 7 is repeatedly performed, so that the control target device 20 corresponding to the image is registered in the user terminal 10, and thereafter the procedure starting from step S200 is repeatedly performed.

In contrast, if the control target device 20 corresponding to the image is a device previously registered in the user terminal 10 at step S230, the user terminal 10 may recognize the control target device 20 by comparing the image information of the control target device 20 with the previously registered information.

If markers are attached to the control target device 20, the user terminal 10 can also recognize the control target device 20 by means of the markers of the input image.

The user terminal 10 recognizes the ID of the control target device 20 and receives the current state information and control information of the control target device 20 from the control target device 20 using the recognized ID at step S240. Of course, when using the previously registered control information of the control target device 20, the user terminal 10 may request only the current state information from the control target device 20.

Thereafter, the user terminal 10 displays the current state information and control information of the control target device 20 on the image, captured at step S200, at step S250. Therefore, from the information included in the image, the user not only can check the current state of the control target device 20, but also can control the control target device 20 based on the control information.

When a control command for the control target device 20 is input from the user on the basis of the control information displayed on the image at step S260, the user terminal 10 transmits the control command input from the user to the control target device 20 at step 270, and stores a control value received from the control target device 20 in compliance with the control command at step S280.

Meanwhile, when the user terminal 10 captures an image of another control target device 20 other than the currently recognized control target device 20 at step S290, the procedure ranging from steps S210 to S280 is repeatedly performed.

Accordingly, the present invention is advantageous in that information about devices familiar to a user is stored in a terminal, and those devices can be simply controlled merely by indicating the devices, so that various devices can be controlled in a wireless manner using the same single user terminal on the basis of augmented reality rather than simply using augmented reality only as a technology for obtaining new information, thus improving convenience.

Further, the present invention is advantageous in that it does not require interoperation with a server located a long distance away, and the present invention is implemented in such a way that a user stores information about a device in a user terminal by initially connecting to the device only once, thus not only realizing higher operating speed compared to the conventional scheme of connecting a server over the Internet so as to obtain augmented reality information, but also being relieved from the restriction of having to access the Internet.

As described above, although the augmented reality-based device control apparatus and method using local wireless communication according to the present invention have been described with reference to the attached drawings, the present invention is not limited to the embodiments and drawings disclosed in the present specification and can be modified and applied in various manners without departing from the technical spirit of the present invention.

What is claimed is:

1. An augmented reality-based device control apparatus using local wireless communication, comprising:
an identification (ID) registration unit for registering ID information about a control target device located neighboring the device control apparatus, and requesting and registering detailed information about an image and a function of the control target device;
an image analysis unit for analyzing an image of the control target device captured by a camera;
to a device recognition unit for comparing a result of analysis of the image by the image analysis unit with the detailed information, thus recognizing the control target device; and
a control unit for requesting current state information from the control target device using the ID information about the control target device recognized by the device recognition unit and controlling a display device for displaying the current state information received from the control target device and the detailed information about the function of the control target device, together with the image of the control target device.

2. The augmented reality-based device control apparatus of claim 1, wherein the detailed information about the control target device comprises at least one of a device name of the control target device, three-dimensional (3D) image information including size and color information of the control target device, control information about the function of the control target device, location information about the control target device, and information about surroundings of the control target device.

3. The augmented reality-based device control apparatus of claim 2, wherein the control unit displays an augmented reality screen required to control the control target device, based on the current state information of the control target device and the control information of the control target device.

4. The augmented reality-based device control apparatus of claim 1, wherein the ID registration unit is configured to recognize and register an ID of the control target device by means of at least one marker attached to the control target device if the marker is attached to the control target device.

5. The augmented reality-based device control apparatus of claim 1, wherein the ID registration unit is configured to receive an ID of the control target device from a user and register the ID if at least one marker is not attached to the control target device.

6. The augmented reality-based device control apparatus of claim 1, wherein the ID registration unit requests the detailed information about the control target device from the control target device, based on the ID information about the control target device, and stores the detailed information about the control target device to correspond to the ID information.

7. The augmented reality-based device control apparatus of claim 1, further comprising a communication module wirelessly connected to the control target device located near the device control apparatus and configured to transmit or receive signals to or from the control target device,
wherein the communication module communicates with the control target device using at least one of Zigbee, IPv6 over Low power Wireless Personal Area Network (6LoWPAN), Bluetooth, Wireless Fidelity (WIFI), and infrared communication.

8. An augmented reality-based device control method using local wireless communication, comprising
registering identification (ID) information about a control target device located at a nearby location, and requesting and registering detailed information about an image and a function of the control target device;
analyzing an image of the control target device captured by a camera;
comparing a result of analysis of the image with the registered detailed information about the control target device, thus recognizing the control target device;
requesting current state information from the control target device using the registered ID information about the control target device; and
displaying the current state information received from the control target device and the detailed information about the function of the control target device, together with the image of the control target device.

9. The augmented reality-based device control method of claim 8, wherein the detailed information about the control target device comprises at least one of a device name of the control target device, three-dimensional (3D) image information including size and color information of the control target device, control information about the function of the control target device, location information about the control target device, and information about surroundings of the control target device.

10. The augmented reality-based device control method of claim 9, wherein the displaying comprises displaying an augmented reality screen required to control the control target device, based on the current state information of the control target device and the control information of the control target device.

11. The augmented reality-based device control method of claim 8, wherein the registering comprises:
if at least one marker is attached to the control target device, capturing the marker; and
recognizing and registering an ID of the control target device by means of the marker.

12. The augmented reality-based device control method of claim 8, wherein the registering comprises:
if at least one marker is not attached to the control target device, receiving an ID of the control target device from a user and registering the ID.

13. The augmented reality-based device control method of claim 8, wherein the registering further comprises requesting the detailed information about the control target device from the control target device, based on the ID information about the control target device,
wherein the detailed information about the control target device is stored to correspond to the ID information.

14. The augmented reality-based device control method of claim 8, wherein the registering is initially performed only once for an identical control target device.
